(19) United States
(12) Patent Application Publication
(10) Pub. No.: US 2026/0184267 A1
(43) Pub. Date: Jul. 2, 2026

(54) DISPLAY SCREEN DEFLECTION MECHANISM, DISPLAY SCREEN ASSEMBLY, AND VEHICLE

(71) Applicant: BYD COMPANY LIMITED, Shenzhen (CN)

(72) Inventors: Zihan WANG, Shenzhen (CN); Xiaoru ZHANG, Shenzhen (CN); Sheng BAI, Shenzhen (CN); Zilong LI, Shenzhen (CN)

(73) Assignee: BYD COMPANY LIMITED, Shenzhen (CN)

(21) Appl. No.: 19/552,581

(22) Filed: Feb. 27, 2026

Related U.S. Application Data
(63) Continuation of application No. PCT/CN2024/114361, filed on Aug. 23, 2024.

(30) Foreign Application Priority Data
Aug. 31, 2023 (CN) 202311130766.7

(51) Int. Cl. B60R 11/02; B60K 35/22; B60K 35/53; B60R 11/00

(52) U.S. Cl. CPC B60R 11/0235; B60K 35/22; B60K 35/53; B60R 2011/0005; B60R 2011/0084; B60R 2011/0092

(57) ABSTRACT

A display screen deflection mechanism, a display screen assembly, and a vehicle are provided. The display screen deflection mechanism includes a mounting base and a push component. The mounting base is used for mounting a display screen, and the mounting base has a first side and a second side opposite to each other in a first direction. The push component includes a driving apparatus and a coupling structure, and through the coupling structure, the driving apparatus drives the mounting base to move relative to the driving apparatus while deflecting toward the first side, or to move relative to the driving apparatus while deflecting movement toward the second side.

### CROSS-REFERENCE TO RELATED APPLICATION

The present disclosure claims the benefit of International Application No. PCT/CN 2024/114361, filed on Aug. 23, 2024, which claims priority to Chinese patent application No. 202311130766.7 filed on Aug. 31, 2023 and entitled “DISPLAY SCREEN DEFLECTION MECHANISM, DISPLAY SCREEN ASSEMBLY, AND VEHICLE”. The disclosures of the prior applications are incorporated herein by reference in their entirety.

### TECHNICAL FIELD

The present disclosure relates to the field of vehicle display screens, and specifically, to a display screen deflection mechanism, a display screen assembly, and a vehicle.

### BACKGROUND

In a related technology, a display screen has fixed viewing angles relative to a driver seat and a front passenger seat. As a result, both a driver and a front passenger may experience illumination interference when viewing information on the display screen, which may cause visual fatigue and reduce the smoothness and comfort of operating the display screen.

### SUMMARY

An aspect of the present disclosure provides a display screen deflection mechanism including: a mounting base, where the mounting base is used for mounting a display screen, and the mounting base has a first side and a second side opposite to each other in a first direction; and a push component, where the push component includes a driving apparatus and a coupling structure, the driving apparatus, through the coupling structure, drives the mounting base to move relative to the driving apparatus while deflecting toward the first side, and/or drives the mounting base to move relative to the driving apparatus while deflecting toward the second side.

Optionally, the movement includes forward movement and/or lateral movement, the forward movement refers to movement along a second direction toward a direction far from the driving apparatus, and the lateral movement refers to movement along the first direction toward the first side or the second side, where the second direction is perpendicular to the first direction.

Optionally, the mounting base moves forward relative to the driving apparatus while deflecting toward the first side, and the mounting base moves forward and laterally relative to the driving apparatus while deflecting toward the second side.

Optionally, the mounting base moves asymmetrically toward the first side and the second side.

Optionally, the display screen deflection mechanism further includes a connecting base, and a guide structure is disposed between the connecting base and the mounting base to guide the movement of the mounting base.

Optionally, the guide structure includes a chute and a slider, the chute is disposed on one of the connecting base and the mounting base, the slider is disposed on the other, and the slider is inserted into the chute and can slide along the chute.

Optionally, the chute extends obliquely from the driving apparatus to the mounting base toward the second side.

Optionally, the chute is configured as an arc-shaped groove and protrudes toward the second side.

Optionally, the chute is disposed on the connecting base, an extension rod extending toward the connecting base is disposed on the mounting base, and the slider is disposed on the extension rod and extends into the chute.

Optionally, one end of the coupling structure is movably connected to a transmission end of the driving apparatus, and the other end is movably connected to the mounting base.

Optionally, two push components are provided, and the coupling structure includes a connecting rod.

Optionally, the driving apparatus includes a motor and a transmission structure, the transmission structure is configured as a lead screw-nut transmission structure, an output shaft of the motor is in transmission connection with a lead screw in the lead screw-nut transmission structure, and one end of the connecting rod is hinged with a nut in the lead screw-nut transmission structure.

Optionally, the connecting base is provided with two slots, the two slots extend along the second direction and penetrate through the connecting base along a third direction, and the nut moves in the slot.

Optionally, a sidewall that is of the connecting base and that is far from the mounting base is provided with two communication openings, the two communication openings communicate with the two slots, respectively, and the lead screw and the nut pass through the slot through the communication opening.

Optionally, a distance between the two slots gradually increases from the motor to the mounting base.

Optionally, the coupling structure includes two connecting rods, the two connecting rods are disposed oppositely in the third direction, one end of each of the two connecting rods is hinged to the mounting base via a first hinge member, and the other end is hinged to the nut via a second hinge member.

Optionally, two connecting protrusions are disposed on a side that is of the mounting base and that faces the connecting base, and each connecting protrusion is hinged to the two connecting rods in the corresponding push component via the first hinge member.

Optionally, a side wall that is of the connecting base and that is close to the mounting base is provided with an avoidance opening to avoid interference with the connecting protrusion.

Optionally, the two connecting rods in each push component are both provided with through holes and are hinged to the nut through second hinge members, respectively, and the second hinge member is configured as a pin and partially provided with screw threads. Both ends of the nut in the third direction are provided with threaded holes, and the pin passes through the through hole and is threaded to the threaded hole.

Optionally, the mounting base is constructed as a Z-shaped plate and includes a first plate body, a second plate body, and a third plate body, and the second plate body is connected between the first plate body and the third plate body; and the two connecting protrusions are disposed on the first plate body, and the third plate body is configured to connect to the display screen.

Optionally, the display screen deflection mechanism further includes a rotation apparatus, the display screen is connected to the mounting base through the rotation apparatus, the rotation apparatus is configured to drive the display screen to rotate around a rotation axis, and the rotation axis is perpendicular to a panel of the display screen.

Optionally, the mounting base is provided with a mounting opening, and the rotation apparatus is fixedly mounted on the mounting base and partially passes through the mounting opening.

The present disclosure further provides a display screen assembly, where the display screen assembly includes a display screen and the display screen deflection mechanism described above, and the display screen is mounted on a mounting base.

The present disclosure further provides a vehicle, where the vehicle includes a vehicle body and the display screen assembly described above, and the display screen is mounted on the vehicle body through the display screen deflection mechanism.

Optionally, the vehicle has a driver seat and a front passenger seat, a first side corresponds to the driver seat, and a second side corresponds to the front passenger seat.

In another aspect, the display screen deflection mechanism provided by the present disclosure is employed, and through the coupling structure, the driving apparatus of the push component can push the mounting base to move while deflecting, so that the display screen can be mounted on the mounting base. When a user needs to view or operate the display screen, the mounting base can be pushed to move by the push component according to an user requirement, so that the display screen can be driven to move in other forms while deflecting toward the first side or the second side (the movement is accompanied by the deflection of the display screen). That is, a position and a deflection angle of the mounting base can be adjusted according to a user requirement, thereby reducing influence caused by factors such as light and distance on viewing or operating the display screen by the user. In addition, when the display screen deflection mechanism according to the present disclosure is used in the vehicle, the first side and the second side may correspond to the driver seat and the passenger seat of the vehicle, respectively. In this way, the display screen can be adjusted to a relatively proper position through the mounting base according to position conditions and requirements of a driver and a front passenger, thereby improving experience feeling of a vehicle user when using the display screen of the vehicle.

Other features and advantages of the present disclosure are described in detail in the following description of embodiments.

### BRIEF DESCRIPTION OF DRAWINGS

The accompanying drawings serve to provide a further understanding of the present disclosure and constitute a part of the specification, and serve to explain the present disclosure together with the following description of embodiments but not to constitute a limitation on the present disclosure. In the accompanying drawings:

FIG. 1 is a perspective view of a display screen assembly according to an exemplary embodiment of the present disclosure;

FIG. 2 is a perspective view of a mounting base and a connecting base of a display screen deflection mechanism according to an exemplary embodiment of the present disclosure;

FIG. 3 is a exploded view of a display screen deflection mechanism according to an exemplary embodiment of the present disclosure;

FIG. 4 is a perspective view of a lead screw and a nut of a display screen deflection mechanism according to an exemplary embodiment of the present disclosure;

FIG. 5 is a top view of a display screen assembly according to an exemplary embodiment of the present disclosure, which is intended to represent an undeflected state of a display screen;

FIG. 6 is a top view of a display screen assembly according to an exemplary embodiment of the present disclosure, which is intended to represent that a display screen moves forward while deflecting toward a first side;

FIG. 7 is a top view of a display screen assembly according to an exemplary embodiment of the present disclosure, which is intended to represent that a display screen moves forward and laterally while deflecting toward a second side; and

FIG. 8 is a schematic diagram of a vehicle according to an exemplary embodiment of the present disclosure.

### DETAILED DESCRIPTION

Specific implementations of the present disclosure are described in detail below with reference to the accompanying drawings. It should be understood that the specific implementations described here are for illustrative and explanatory purposes only and is not intended to limit the present disclosure.

In the present disclosure, unless stated to the contrary, directional terms such as “front” and “rear” are defined based on relative positions between a mounting base and a driving apparatus, where “front” indicates a direction in which the mounting base is far from the driving apparatus, and “rear” indicates a direction in which the mounting base is close to the driving apparatus. “Inside and outside” refers to “inside and outside” relative to a contour of a corresponding part, and “far and near” refers to “far and near” relative to a reference object. In addition, terms such as “first”, “second”, and the like used in the present disclosure are intended to distinguish one element from another, and are not sequential or important. In the following description, when referring to the accompanying drawings, same reference numerals in different accompanying drawings indicate the same or similar elements unless otherwise explained. The foregoing definitions are intended to explain and illustrate the present disclosure and should not be construed as limiting the present disclosure.

A display screen deflection mechanism 10 according to the present disclosure may be used in any suitable scenario. The following describes the display screen deflection mechanism 10 used in a vehicle as an example.

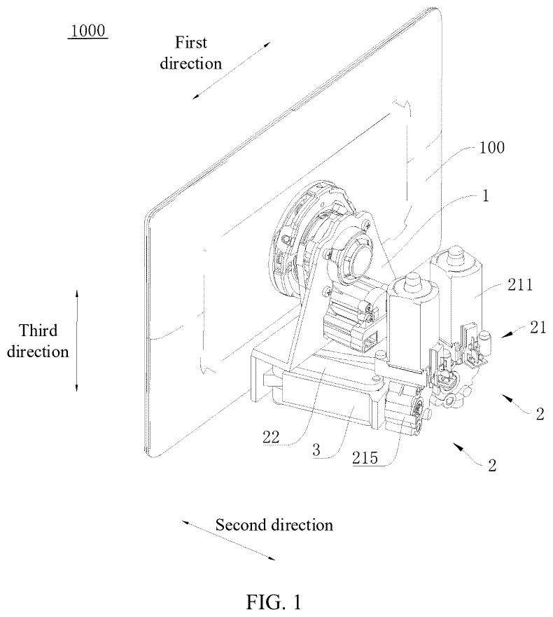

In an exemplary embodiment according to the present disclosure, with reference to FIG. 1, the present disclosure provides a display screen deflection mechanism 10, where the display screen deflection mechanism 10 includes: a mounting base 1, where the mounting base 1 is used for mounting a display screen 100, and the mounting base 1 has a first side 101 and a second side 102 opposite to each other in a first direction; and a push component 2, where the push component 2 includes a driving apparatus 21 and a coupling structure 20, the driving apparatus 21, through the coupling structure 20, drives the mounting base 1 to move relative to the driving apparatus 21 while deflecting toward the first side 101, and/or drives the mounting base 1 to move relative to the driving apparatus 21 while deflecting toward the second side 102.

According to foregoing technical solutions, the display screen deflection mechanism 10 provided by present disclosure is employed, and through the coupling structure 20, the driving apparatus 21 of the push component 2 can push the mounting base 1 to move while deflecting, so that the display screen 100 can be mounted on the mounting base 1. When a user needs to view or operate the display screen 100, the mounting base 1 can be pushed to move by the push component 2 according to an user requirement, so that the display screen 100 can be driven to move in other forms while deflecting toward the first side 101 or the second side 102 (the movement is accompanied by the deflection of the display screen 100). That is, a position and a deflection angle of the mounting base 1 can be adjusted according to the user requirement, thereby reducing influence caused by factors such as light and distance on viewing or operating the display screen 100 by the user. In addition, when the display screen deflection mechanism 10 according to the present disclosure is used in the vehicle, the first side 101 and the second side 102 may correspond to the driver seat and the passenger seat of the vehicle, respectively. In this way, the display screen 100 can be adjusted to a relatively proper position through the mounting base 1 according to position conditions and requirements of a driver and a front passenger, thereby improving experience feeling of a vehicle user when using the display screen 100 of the vehicle.

In an exemplary embodiment according to the present disclosure, with reference to FIG. 5 to FIG. 7, the mounting base 1 may deflect toward either the first side 101 or the second side 102. The mounting base 1 moves relative to the driving apparatus 21 while deflecting toward the first side 101. In addition, the mounting base 1 moves relative to the driving apparatus 21 while deflecting toward the second side 102. It may be understood that, in some embodiments, the mounting base 1 can deflect toward either the first side 101 or the second side 102, and can move relative to the driving apparatus 21 while deflecting. In some other embodiments, the mounting base 1 is capable of deflecting toward either the first side 101 or the second side 102, but the mounting base 1 can solely move relative to the driving apparatus 21 while deflecting toward the first side 101 (in this embodiment, the mounting base 1 does not move relative to the driving apparatus 21 while deflecting toward the second side 102), or can solely move relative to the driving apparatus 21 while deflecting toward the second side 102 (in this embodiment, the mounting base 1 does not move relative to the driving apparatus 21 while deflecting toward the first side 101).

It should be noted that with reference to FIG. 5 to FIG. 7, the movement includes forward movement and/or lateral movement. The forward movement refers to movement along a second direction toward a direction far from the driving apparatus 21, and the lateral movement refers to movement along the first direction toward the first side 101 or the second side 102, where the second direction is perpendicular to the first direction.

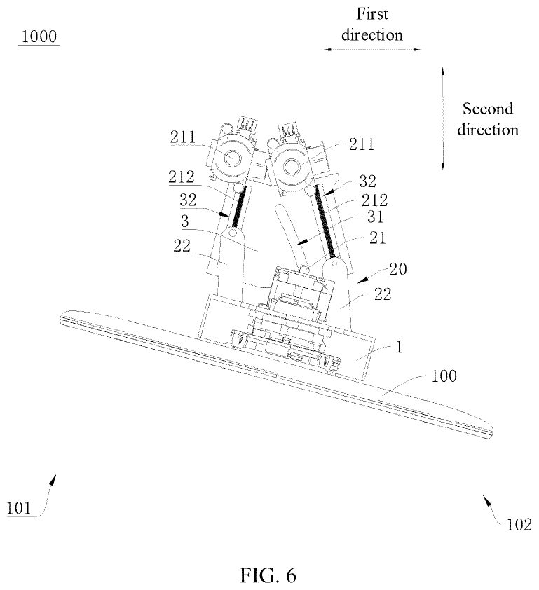

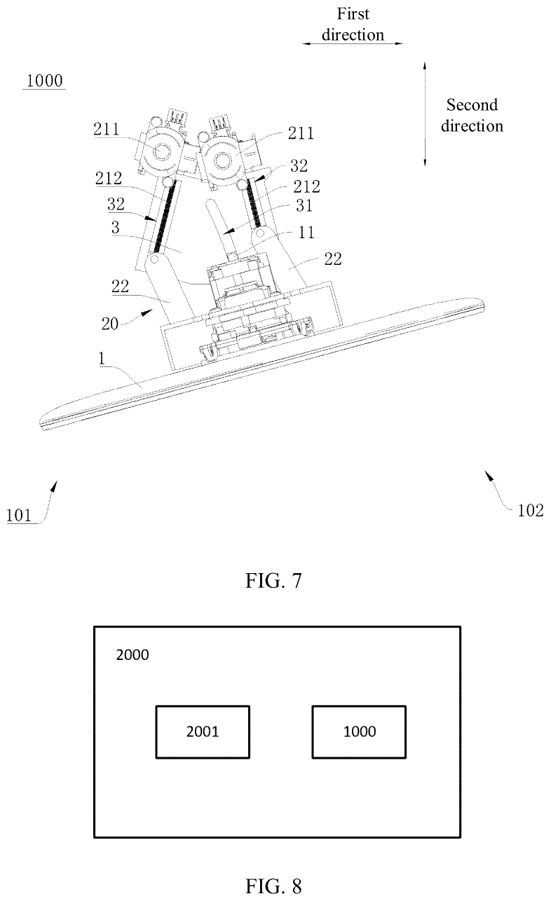

In an embodiment according to the present disclosure, with reference to FIG. 5 to FIG. 7, the mounting base 1 may move asymmetrically toward the first side 101 and the second side 102, where the mounting base 1 moves forward relative to the driving apparatus 21 while deflecting toward the first side 101 (as shown in FIG. 6), and the mounting base 1 moves forward and laterally relative to the driving apparatus 21 while deflecting toward the second side 102 (as shown in FIG. 7). The lateral movement is that the mounting base 1 moves toward the second side 102 along the first direction.

In the foregoing design manner, for example, when the display screen deflection mechanism 10 according to the present disclosure is used in a vehicle, when the first side 101 is a driver seat side and the second side 102 is a front passenger seat side, the display screen 100 moves forward solely while deflecting toward a driver, so that the driver can view the display screen 100 better, and the display screen 100 does not interfere with the driver. When the display screen 100 moves forward and laterally while deflecting toward a front passenger, the display screen 100 is closer to the front passenger, so that the front passenger can view and operate the display screen 100.

In other embodiments, the mounting base 1 may move symmetrically toward the first side 101 and the second side 102. For example, the mounting base 1 moves forward and laterally relative to the driving apparatus 21 while deflecting toward the first side 101 (the lateral movement refers to that the mounting base 1 moves toward the first side 101 in the first direction), and the mounting base 1 moves forward and laterally relative to the driving apparatus 21 while deflecting toward the second side 102 (the lateral movement refers to that the mounting base 1 moves toward the second side 102 in the first direction).

To guide deflection and movement of the mounting base 1, in an embodiment according to the present disclosure, with reference to FIG. 1 to FIG. 3, the display screen deflection mechanism 10 further includes a connecting base 3, and a guide structure 30 is disposed between the connecting base 3 and the mounting base 1 to guide movement of the mounting base 1. The guide structure 30 may include a chute 31 and a slider 11, one of the connecting base 3 and the mounting base 1 is provided with the chute 31, and the other is provided with the slider 11. The slider 11 is inserted into the chute 31 and can slide along the chute 31. In other embodiments, the guide structure 30 may include a track and a movable block, and the movable block slides along the track.

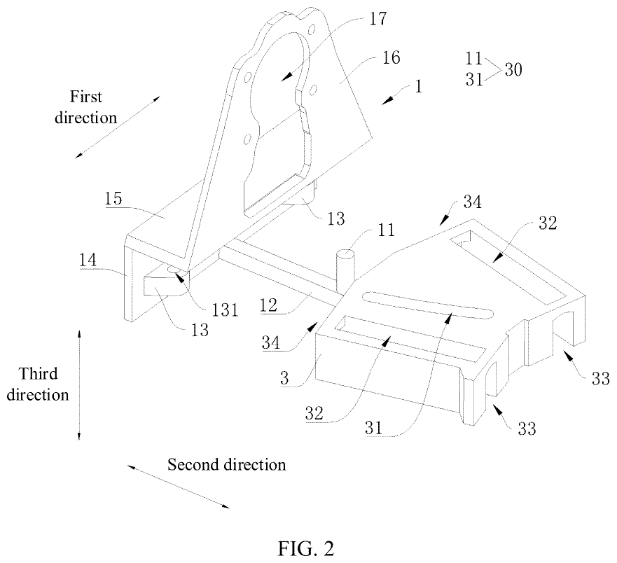

With regard to position setting of the chute 31 and the slider 11, in an exemplary embodiment according to the present disclosure, with reference to FIG. 2, the chute 31 is disposed on the connecting base 3, an extension rod 12 extending toward the connecting base 3 is disposed on the mounting base 1, and the slider 11 is disposed on the extension rod 12 and extends into the chute 31. The mounting base 1 may be configured as any suitable structure. In an embodiment according to the present disclosure, with reference to FIG. 2, the mounting base 1 is configured as a Z-shaped plate and includes a first plate body 14, a second plate body 15, and a third plate body 16. The second plate body 15 is connected between the first plate body 14 and the third plate body 16, and the third plate body 16 is configured to connect to the display screen 100. The extension rod 12 is fixedly mounted on the first plate body 14, and a space enclosed by the first plate body 14 and the second plate body 15 is configured to receive an end portion of the connecting base 3.

In an exemplary embodiment according to the present disclosure, with reference to FIG. 1 to FIG. 3, one end of the coupling structure 20 is movably connected to a transmission end of the driving apparatus 21, and the other end is movably connected to the mounting base 1, so that the mounting base 1 can be driven by the push component 2. Two push components 2 may be disposed, and the coupling structure 20 includes a connecting rod 22. The two push components 2 may be spaced apart in the first direction, and under the transmission of the connecting rod 22 and the guidance of the guide structure 30, the mounting base 1 can move along a predetermined trajectory under the driving of the driving apparatus 21.

It should be noted that in one embodiment, the two coupling structures can start to move simultaneously to drive the mounting base 1 to deflect and move. When it is necessary to drive the mounting base 1 to deflect and move forward toward the first side 101, with reference to FIG. 5 and FIG. 6, it is necessary to make the coupling structure 20 far from the first side 101 push at a relatively high speed and the coupling structure 20 close to the first side 101 push at a relatively low speed. When it is necessary to drive the mounting base 1 to deflect, and move forward and laterally toward the second side 102, with reference to FIG. 5 and FIG. 7, it is necessary to make the coupling structure 20 far from the second side 102 push at a relatively high speed and the coupling structure 20 close to the second side 102 push at a relatively low speed. In another embodiment, the two coupling structures 20 may push simultaneously at a same speed. Upon reaching to a certain extent, one coupling structure 20 stops pushing, and the other coupling structure 20 continues pushing, thereby achieving a purpose of driving the mounting base 1 to deflect and move. In still another embodiment, one of the coupling structures 20 may push one side of the mounting base 1, and after the coupling structure 20 has pushed this side of the mounting base 1 by a certain distance, the other coupling structure 20 may then push the other side of the mounting base 1, thereby achieving an effect of pushing the mounting base 1 to deflect and move. The present disclosure is intended to implement that the mounting base 1 drives the display screen 100 to deflect and move. Under a structure of the present disclosure, a driving manner for implementing deflection and movement is not specifically limited.

In addition, when the two coupling structures 20 employ different pushing manners, shapes of corresponding chutes 31 may be different (the shapes of the chutes 31 are mainly adapted to pushing manners of the two coupling structures 20). In an embodiment according to the present disclosure, with reference to FIG. 2 and in conjunction with FIG. 6 and FIG. 7, as the mounting base 1 moves asymmetrically when deflecting toward the first side 101 and the second side 102, the chute 31 extends obliquely from the driving apparatus 21 to the mounting base 1 toward the second side 102. The chute 31 extends from the driving apparatus 21 to the mounting base 1, so that the mounting base 1 can move forward. In addition, the chute 31 is inclined solely toward the second side 102, so that the mounting base 1 can move laterally toward the second side 102 while deflecting the second side 102, whereas the mounting base 1 moves forward solely while deflecting toward the first side 101, without lateral movement.

To make sliding of the mounting base 1 more stable, in an embodiment according to the present disclosure, with reference to FIG. 2 and in conjunction with FIG. 6 and FIG. 7, the chute 31 is configured as an arc-shaped groove and protrudes toward the second side 102. It should be noted that, the arc-shaped groove protrudes toward one side due to its radian. It may be understood that the chute 31 according to the present disclosure may protrude toward a direction far from the first side 101 when viewed in a plane of FIG. 6. The shape of the chute 31 is designed to adapt to a pushing process of the push component 2 and a travel path of the mounting base 1. In other embodiments, the chute 31 may also be configured as a straight groove.

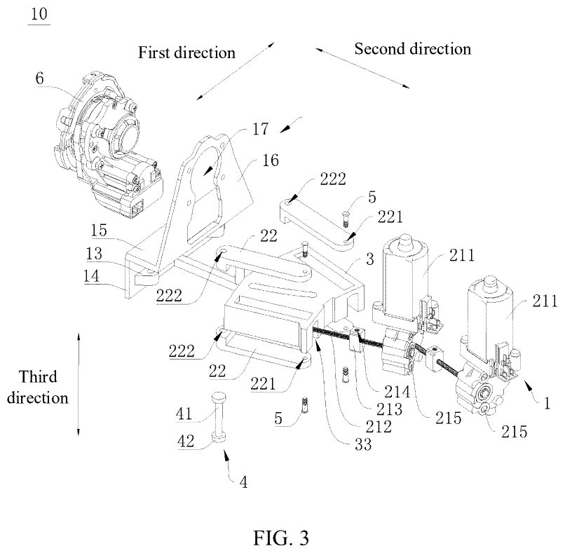

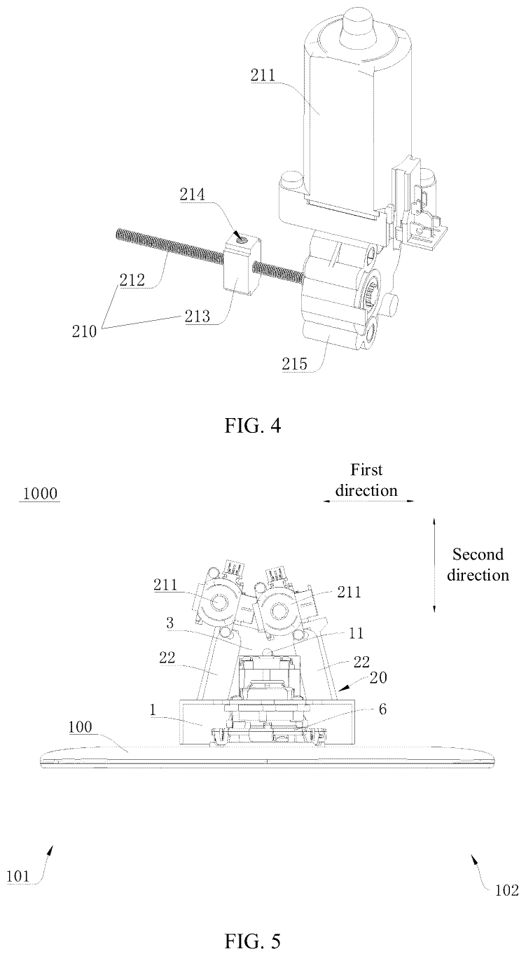

In an exemplary embodiment according to the present disclosure, with reference to FIG. 3 and FIG. 4, the driving apparatus 21 may include a motor 211 and a transmission structure 210, and the transmission structure 210 is configured as a lead screw-nut transmission structure. An output shaft of the motor 211 is in transmission connection with a lead screw 212 in the lead screw-nut transmission structure, and one end of the connecting rod 22 is hinged with a nut 213 in the lead screw-nut transmission structure. That is, the motor 211 drives the lead screw 212 to rotate, and the lead screw 212 drives the nut 213 to move, thereby pushing the connecting rod 22. Afterwards, the connecting rod 22 pushes the mounting base 1 to move, thereby driving the movement of the mounting base 1. In addition, to reduce a rotation speed of the lead screw 212, the driving apparatus 21 may further include a speed reducer 215, the motor 211 is in transmission connection with the lead screw 212 through the speed reducer 215, thereby driving the lead screw 212 to rotate. A commutation structure (for example, a commutation structure composed of bevel gears) may be further disposed in the speed reducer 215, so that a rotation axis of the motor 211 and an axis of the lead screw 212 are perpendicular to each other. That is, a length direction of the motor 211 is disposed in the third direction, thereby saving a dimension of the entire display screen deflection mechanism 10 in the second direction.

To provide tracks for sliding of the two nuts 213, in an embodiment according to the present disclosure, with reference to FIG. 2 and FIG. 3, the connecting base 3 is provided with two slots 32, the two slots 32 extend along the second direction and penetrate through the connecting base 3 along the third direction, and the nut 213 moves in the slot 32. It may be understood that the slot 32 penetrates through the connecting base 3 in the third direction, so that the nut 213 can be movably connected to the connecting rod 22.

In an exemplary embodiment according to the present disclosure, with reference to FIG. 2 and FIG. 3, to facilitate mounting of the lead screw 212 and the nut 213, a sidewall that is of the connecting base 3 and that is far from the mounting base 1 are provided with two communication openings 33, and the two communication openings 33 communicate with the two slots 32, respectively. The lead screw 212 and the nut 213 pass through the slot 32 through the communication opening 33. In other embodiments, the connecting base 3 may not be provided with the communication opening 33, and the lead screw 212 and the nut 213 can be mounted into the slot 32 from both sides of the slot 32 in the third direction. In this implementation, the lead screw 212 may pass out from a tail end of the connecting base 3 to be in transmission connection with the motor 211, or the lead screw 212 may not pass out of the connecting base 3, but the motor 211 is in transmission connection with the lead screw 212 in a sprocket chain transmission manner.

Further, in an exemplary embodiment according to the present disclosure, with reference to FIG. 2 and FIG. 3, a distance between the two slots 32 may gradually increase from the motor 211 to the mounting base 1 to make movement of the mounting base 1 more stable. In other embodiments, the distance between the two slots 32 may remain constant, that is, the two slots 32 are disposed in parallel.

In other exemplary embodiments, each coupling structure 20 may include one connecting rod 22. However, to make connection more stable, in the exemplary embodiment according to the present disclosure, with reference to FIG. 2 and FIG. 3, the coupling structure 20 includes two connecting rods 22, the two connecting rods 22 are disposed oppositely in the third direction, and the two connecting rods 22 are located on both sides of the connecting base 3 in the third direction, respectively, one end of each of the two connecting rods 22 is hinged with the mounting base 1 via a first hinge member 4, and the other end is hinged to the nut 213 via a second hinge member 5. Two connecting protrusions 13 are disposed on one side that is of the mounting base 1 and that faces the connecting base 3, the two connecting protrusions 13 are disposed on the first plate body 14, the two connecting protrusions 13 are spaced apart in the first direction, and each connecting protrusion 13 is hinged with the two connecting rods 22 in the corresponding push component 2 via the first hinge member 4. A sidewall that is of the connecting base 3 and that is close to the mounting base 1 is provided with two avoidance openings 34, the two avoidance openings 34 are spaced apart in the first direction to avoid interference with the two connecting protrusions 13, respectively, so that the mounting base 1 can be more compactly disposed with the connecting base 3 without offsetting.

With regard to the first hinge member 4, in an exemplary embodiment according to the present disclosure, with reference to FIG. 2 and FIG. 3, the first hinge member 4 includes a hinge pin 41 and a locking nut 42, and the connecting protrusion 13 is provided with a mounting hole 131, an end portion that is of the connecting rod 22 and that is close to the mounting base 1 is provided with a connecting hole 222, the hinge pin 41 passes through the mounting hole 131 and the connecting hole 222 and is threaded to the locking nut 42, the connecting protrusion 13 and the connecting rod 22 are both in rotatable fit with the hinge pin 41, and the first hinge member 4 is located on one side that is of the connecting base 3 and that is close to the mounting base 1. In other exemplary embodiments, the first hinge member 4 may also be configured as any other structure capable of achieving hinge, which is not specifically limited by the present disclosure.

With regard to the second hinge member 5, in an exemplary embodiment according to the present disclosure, with reference to FIG. 3, the two connecting rods 22 in each push component 2 are both provided with through holes 221 and are hinged to the nut 213 by second hinge members 5, respectively. The second hinge member 5 is configured as a pin and is partially provided with screw threads, and both ends of the nut 213 in the third direction are provided with threaded holes 214, and the pin passes through the through hole 221 and is threaded to the threaded hole 214. In some embodiments, an end portion of the second hinge member 5 is provided with screw threads, and only the end portion of the second hinge member 5 provided with the screw threads is connected to the threaded hole 214 of the nut 213. The connecting rod 22 is sleeved outside a position where the second hinge member 5 is not provided with the screw threads, so that the connecting rod 22 can rotate relative to the second hinge member 5. In other exemplary embodiments, the second hinge member 5 may not be provided with screw threads. In this case, the end portion of the second hinge member 5 may be inserted into the nut 213 and soldered and fixed to the nut 213.

It should be noted that, in one embodiment, the two motors 211 may respectively drive the two nuts 213 to start moving simultaneously to drive the mounting base 1 to deflect and move. However, when the mounting base 1 needs to be driven to deflect and move forward toward the first side 101, with reference to FIG. 5 and FIG. 6. It is necessary to make the nut 213 far from the first side 101 move faster and the nut 213 close to the first side 101 move slower. When it is necessary to drive the mounting base 1 to offset, move forward and move laterally toward the second side 102, with reference to FIG. 5 and FIG. 7, it is necessary to make the nut 213 far from the second side 102 faster and the nut 213 close to the second side 102 slower. In another embodiment, the two nuts 213 may move simultaneously at a same speed. Upon reaching a certain extent, one nut 213 stops moving, and the other nut 213 continues moving, thereby achieving an objective of driving the mounting base 1 to deflect and move. In still another embodiment, one of the nuts 213 may move first, and after the nut 213 moves a certain distance, the other nut 213 moves again, which may also implement a function of driving the mounting base 1 to deflect.

To drive the display screen 100 to rotate, in an embodiment according to the present disclosure, with reference to FIG. 1 and FIG. 3, the display screen deflection mechanism 10 further includes a rotation apparatus 6, and the display screen 100 is connected to the mounting base 1 through the rotation apparatus 6. The rotation apparatus 6 is configured to drive the display screen 100 to rotate around a rotation axis, where the rotation axis is perpendicular to a panel of the display screen 100. Through the foregoing design manner, after the display screen 100 is mounted on the rotation apparatus 6, a rotation degree of the rotation apparatus 6 can be adjusted according to a user requirement, thereby driving the display screen 100 to rotate. It should be noted that the rotation apparatus 6 may include a drive motor 211 and a speed reducer 215. The drive motor 211 drives the display screen 100 to rotate through the speed reducer 215. In other embodiments, the rotation apparatus 6 may be constructed as other structures that can drive the display screen 100 to rotate.

In an embodiment according to the present disclosure, with reference to FIG. 2 and FIG. 3, the mounting base 1 is provided with a mounting opening 17, and the rotation apparatus 6 is fixedly mounted on the mounting base 1 and partially passes through the mounting opening 17. The mounting opening 17 is formed in the third plate body 16 of the mounting base 1.

Based on the foregoing solutions, the present disclosure further provides a display screen assembly 1000. With reference to FIG. 1, the display screen assembly 1000 may include a display screen 100 and the display screen deflection mechanism 10 described above, where the display screen 100 is mounted on a mounting base 1 (which may be mounted on a rotation apparatus 6 on the mounting base 1). The display screen assembly 1000 may be pushed by two push components 2 to move forward while deflecting toward the first side 101, and to move forward and laterally while deflecting toward the second side 102.

Based on the foregoing solutions, the present disclosure further provides a vehicle 2000. With reference to FIG. 8, the vehicle 2000 includes a vehicle body 2001 and the display screen assembly 1000 described above, and the display screen 100 is mounted on the vehicle body 2001 through the display screen deflection mechanism 10. A preset included angle may be formed between the display screen 100 and a horizontal plane. The preset included angle may range from 40° to 90°. For example, the preset included angle may be 40°, 50°, 60°, 90°, or the like. In addition, in an embodiment according to the present disclosure, the vehicle 2000 has a driver seat and a passenger seat. When the display screen assembly 1000 is mounted in a front row of the vehicle 2000, a first side 101 may correspond to the driver seat, and a second side 102 may correspond to the passenger seat. In other embodiments, the display screen assembly 1000 may also be used in a rear row of the vehicle 2000 and is mounted at a middle position in front of a rear seat of the vehicle 2000. That is, the first side 101 corresponds to one side of the rear row of the vehicle 2000, and the second side 102 corresponds to the other side of the rear row of the vehicle 2000.

In some embodiments, the display screen deflection mechanism 10, the display screen assembly 1000, and the vehicle according to the present disclosure are employed. The two push components 2 are configured to push the mounting base 1 to different degrees, so that the mounting base 1 can be deflected. When the mounting base 1 is deflected, in conjunction with the guidance of the guide structure 30, the mounting base 1 can drive the display screen 100 to move forward while deflecting toward the first side 101, and to move forward and laterally while deflecting toward the second side 102 (where the lateral movement refers to moving laterally toward the second side 102). In this way, a position and a deflection angle of the mounting base 1 can be adjusted according to a user requirement, thereby reducing influence caused by factors such as light and distance on viewing or operating the display screen 100 by the user. In addition, when the display screen deflection mechanism 10 according to the present disclosure is used in the vehicle, the first side 101 and the second side 102 may correspond to the driver seat and the passenger seat of the vehicle 2000, respectively. The display screen 100 may be adjusted to a relatively proper position by using the mounting base 1 according to position conditions and requirements of the driver and the front passenger. In this way, experience feeling of a vehicle user when using the vehicle display screen 100 is improved.

Preferred implementations of the present disclosure are described in detail described above with reference to the accompanying drawings. However, the present disclosure is not limited to specific details in the foregoing implementations. Within the technical concept of the present disclosure, various simple modifications can be made to the technical solutions of the present disclosure, and these simple modifications all fall within the scope of protection of the present disclosure. It should also be noted that the various specific technical features described in the foregoing implementations can be combined in any suitable manner, provided that there is no contradiction. To avoid unnecessary repetition, the present disclosure does not provide separate descriptions for all possible combination modes.

In addition, various different implementations of the present disclosure can also be combined arbitrarily, provided that they do not violate the principles of the present disclosure, and should also be considered as the content disclosed by the present disclosure.

What is claimed is:

1. A display screen deflection mechanism, wherein the display screen deflection mechanism comprising:
a mounting base, the mounting base being used for mounting a display screen, and the mounting base having a first side and a second side opposite to each other in a first direction; and
a push component, the push component comprising a driving apparatus and a coupling structure, the driving apparatus, through the coupling structure, driving the mounting base to move relative to the driving apparatus while deflecting toward the first side, or to move relative to the driving apparatus while deflecting toward the second side.

2. The display screen deflection mechanism according to claim 1, wherein the movement comprises forward movement or lateral movement, and the forward movement refers to movement along a second direction toward a direction far from the driving apparatus, the lateral movement refers to movement along the first direction toward the first side or the second side, and the second direction is perpendicular to the first direction.

3. The display screen deflection mechanism according to claim 2, wherein the mounting base moves forward relative to the driving apparatus while deflecting toward the first side, and the mounting base moves forward and laterally relative to the driving apparatus while deflecting toward the second side.

4. The display screen deflection mechanism according to claim 1, wherein the mounting base moves asymmetrically toward the first side and the second side.

5. The display screen deflection mechanism according to claim 1, wherein the display screen deflection mechanism further comprises a connecting base, and a guide structure is disposed between the connecting base and the mounting base to guide movement of the mounting base.

6. The display screen deflection mechanism according to claim 5, wherein the guide structure comprises a chute and a slider, the chute is disposed on one of the connecting base and the mounting base, the slider is disposed on the other, and the slider is inserted into the chute and capable of sliding along the chute.

7. The display screen deflection mechanism according to claim 6, wherein the chute extends obliquely from the driving apparatus to the mounting base toward the second side.

8. The display screen deflection mechanism according to claim 7, wherein the chute is configured as an arc-shaped groove and protrudes toward the second side.

9. The display screen deflection mechanism according to claim 6, wherein the chute is disposed on the connecting base, an extension rod extending toward the connecting base is disposed on the mounting base, and the slider is disposed on the extension rod and extends into the chute.

10. The display screen deflection mechanism according to claim 1, wherein one end of the coupling structure is movably connected to a transmission end of the driving apparatus, and the other end is movably connected to the mounting base.

11. The display screen deflection mechanism according to claim 10, wherein two push components are provided, and the coupling structure comprises a connecting rod.

12. The display screen deflection mechanism according to claim 11, wherein the driving apparatus comprises a motor and a transmission structure, and the transmission structure is configured as a lead screw-nut transmission structure, wherein an output shaft of the motor is in transmission connection with a lead screw in the lead screw-nut transmission structure, and one end of the connecting rod is hinged with a nut in the lead screw-nut transmission structure.

13. The display screen deflection mechanism according to claim 12, wherein the connecting base is provided with two slots, the two slots extend along the second direction and penetrate through the connecting base along a third direction, and the nut moves in the slot.

14. The display screen deflection mechanism according to claim 13, wherein a sidewall that is of the connecting base and that is far from the mounting base is provided with two communication openings, the two communication openings communicate with the two slots, respectively, and the lead screw and the nut pass through the slot through the communication opening.

15. The display screen deflection mechanism according to claim 13, wherein a distance between the two slots gradually increases from the motor to the mounting base.

16. The display screen deflection mechanism according to claim 12, wherein the coupling structure comprises two connecting rods, and the two connecting rods are arranged oppositely in the third direction; and one end of each of the two connecting rods is hinged with the mounting base via a first hinge member, and the other end is hinged with the nut via a second hinge member.

17. The display screen deflection mechanism according to claim 1, wherein the display screen deflection mechanism further comprises a rotation apparatus, the display screen is connected to the mounting base through the rotation apparatus, the rotation apparatus is configured to drive the display screen to rotate around a rotation axis, and the rotation axis is perpendicular to a panel of the display screen.

18. A display screen assembly, wherein the display screen assembly comprises a display screen and the display screen deflection mechanism according to claim 1, and the display screen is mounted on the mounting base.

19. A vehicle, wherein the vehicle comprises a vehicle body and the display screen assembly, the display screen assembly includes a display screen and the display screen deflection mechanism according to claim 1, and the display screen is mounted on the vehicle body through the display screen deflection mechanism.

20. The vehicle according to claim 19, wherein the vehicle has a driver seat and a front passenger seat, a first side corresponds to the driver seat, and a second side corresponds to the front passenger seat.
